(19) United States
(12) Patent Application Publication
(10) Pub. No.: US 2007/0142980 A1
(43) Pub. Date: Jun. 21, 2007

(54) Avionics method and apparatus

(76) Inventors: Marc Ausman, Albuquerque, NM (US); Jacob Dostal, Albuquerque, NM (US); Adam Church, Socorro, NM (US)

Correspondence Address: V. Gerald Grafe, esq., P.O. Box 2689, Corrales, NM, 87048, US

(21) Appl. No.: 11/311,060

(22) Filed: Dec. 19, 2005

(51) Int. Cl. G01C 23/00

(52) U.S. Cl. 701/3

(57) ABSTRACT

The present invention comprises methods and apparatuses for sensing attributes of an aircraft and efficiently communicating relevant attributes to a pilot. The invention allows a state of the aircraft to be determined, and then used to control systems, configure displays, select checklists relevant to the determined state, and automatically respond to emergencies based on the aircraft state. Embodiments of the invention can use the determined state of the aircraft to monitor and control electrical sensors and system as appropriate for the determined state; to communication information relevant to the determined state to a pilot (e.g., by displaying gauges in a manner and priority specific to the determined state); and to display contextually-relevant checklists (e.g., displaying a checklist of actions necessary for an aircraft in the determined state).

### BACKGROUND

The present invention relates to avionics. Modern commercial/private aircraft, as well as older aircraft, include a myriad of instrumentation panels associated with electronic devices having controls, displays, and software applications, which are used to present information to pilots and/or copilots during flight. The electronic devices, controls, displays and applications are interfaced together to form avionics equipment within the aircraft. Pilots (where “pilot” includes copilots and any other controller of the aircraft) access one or more interface devices of the avionics equipment prior to and during the flight. Some of this information presented monitors the status of equipment on the aircraft, while other switches and knobs are used to control functions of the aircraft such as throttles (engine speed), switches (lights, radios, etc), levers (landing gear and flaps), and controls for navigation, for example.

Avionics are important because they enable the pilot to control the aircraft, monitor and control its systems, and navigate the aircraft. Avionics systems today are manual and therefore the pilot must manually select the proper switch, knob, etc. to control a certain function in response to aircraft and environmental conditions. This action can be the result of normal activities, and is usually read from a checklist so as not to miss anything, or the result of a warning display, at which time the pilot must react accordingly. Pilot error, in the form of not knowing what to do or reacting improperly, leads to increased accident and death rates. Crashes can also result from pilots being distracted by an emergency and not maintaining control of the aircraft because they are busy troubleshooting or reacting to the problem. Additionally, many of the settings are the same on each flight, and the pilot must manually perform the same actions repeatedly. Such actions have the possibility to distract the pilot's awareness from the surrounding situation, or the state of the aircraft in flight. Such repetitions are non-value-added work, and the resultant distractions can increase the possibility of an accident.

General aviation accident statistics show that the accident rate for single pilot, non professionally flown aircraft is significantly greater than that for dual-pilot professionally flown aircraft.

Accordingly, there is a need for methods and apparatuses that reduce pilot workload and increase the performance and efficiency of the pilot's control of the aircraft through automation. This ensures both a proper response to certain emergencies, and frees up awareness for the pilot to focus on flying the aircraft rather than 1) performing routine and repetitive functions, or 2) responding manually to certain emergencies.

### SUMMARY OF THE INVENTION

The present invention provides methods and apparatuses that reduce pilot workload and increase the performance and efficiency of the pilot's control of the aircraft. The present invention comprises methods and apparatuses for sensing attributes of an aircraft and efficiently communicating relevant attributes to a pilot. The invention allows a state of the aircraft to be determined, and then used to automatically control systems, configure displays, select checklists relevant to the determined state, and respond appropriately to emergencies. Embodiments of the invention can use the determined state of the aircraft to monitor and control electrical sensors and system as appropriate for the determined state; to communication information relevant to the determined state to a pilot (e.g., by displaying gauges in a manner and priority specific to the determined state); to display contextually-relevant checklists (e.g., displaying a checklist of actions necessary for an aircraft in the determined state); and to use the determined state to determine how to respond to certain emergency situations.

Embodiments of the present invention use the determined state of the aircraft to monitor and control electrical sensors and system as appropriate for the determined state; to communication information relevant to the determined state to a pilot (e.g., by displaying gauges in a manner and priority specific to the determined state); and to display contextually-relevant checklists (e.g., displaying a checklist of actions necessary for an aircraft in the determined state). For example, certain attributes can be displayed more or less prominently depending on the state of the aircraft. Embodiments of the present invention use the determined state of the aircraft to configure controllable aircraft subsystems. For example, certain engine or electrical subsystems can be automatically configured differently in different states. Additional examples of attributes and controls are presented below.

### DESCRIPTION OF THE FIGURES

The invention is explained by using embodiment examples and corresponding drawings, which are incorporated into and form part of the specification.

FIG. 1 is a schematic depiction of an apparatus according to the present invention.

FIG. 2 is a schematic depiction of transitions between various states.

FIG. 3 is a schematic illustration of an example programmable display, configured for an aircraft in a preflight state.

FIG. 4 is a schematic illustration of an example programmable display, configured for an aircraft in a pre-start state.

FIG. 5 is a schematic illustration of an example programmable display, configured for an aircraft in a start state (but prior to engine start).

FIG. 6 is a schematic illustration of an example programmable display, configured for an aircraft in a start state oust after engine start).

FIG. 7 is a schematic illustration of an example programmable display, configured for an aircraft in a taxi state.

FIG. 8 is a schematic illustration of an example programmable display, configured for an aircraft in a run-up state.

FIG. 9 is a schematic illustration of an example programmable display, configured for an aircraft in a Takeoff state.

FIG. 10 is a schematic illustration of an example programmable display, configured for an aircraft in a Cruise state.

FIG. 11 is a schematic illustration of an example programmable display, configured for an aircraft in a Cruise state (after completion of a checklist such as that in the example of FIG. 10).

FIG. 12 is a schematic illustration of an example programmable display, configured for an aircraft in a landing state.

FIG. 13 is a schematic illustration of an example programmable display, configured for an aircraft in a Maneuver state.

FIG. 14 is a schematic illustration of an example programmable display, configured for an aircraft in a Cruise state, in the presence of a failure detected by the system.

FIG. 15 is a schematic block diagram of an example embodiment of the present invention.

FIG. 16 is a schematic illustration of an embodiment of the present invention.

FIG. 17 is a schematic illustration of computer software suitable for implementing an embodiment of the present invention.

### DETAILED DESCRIPTION

The present invention provides methods and apparatuses that reduce pilot workload and increase the performance and efficiency of the pilot's control of the aircraft. Embodiments of the present invention accept inputs from various aircraft attributes. As used herein, an aircraft “attribute” includes anything that can be sensed relative to the aircraft. Examples of attributes are described below. From the aircraft attributes, the present invention determines a state of the aircraft. The “state” of the aircraft includes any of the various flight or control states encountered in flying, operating, or maintaining an aircraft. There are various terms and definitions for such states appreciated by those skilled in the art. For convenience of discussion, representative states are described below. Those skilled in the art will appreciate other terms and other definitions of states that can be accommodated in the present invention.

Embodiments of the present invention use the determined state of the aircraft to monitor and control electrical sensors and system as appropriate for the determined state; to communication information relevant to the determined state to a pilot (e.g., by displaying gauges in a manner and priority specific to the determined state); and to display contextually-relevant checklists (e.g., displaying a checklist of actions necessary for an aircraft in the determined state). For example, certain attributes can be displayed more or less prominently depending on the state of the aircraft. Embodiments of the present invention use the determined state of the aircraft to configure controllable aircraft subsystems. For example, certain engine or electrical subsystems can be automatically configured differently in different states. Additional examples of attributes and controls are presented below.

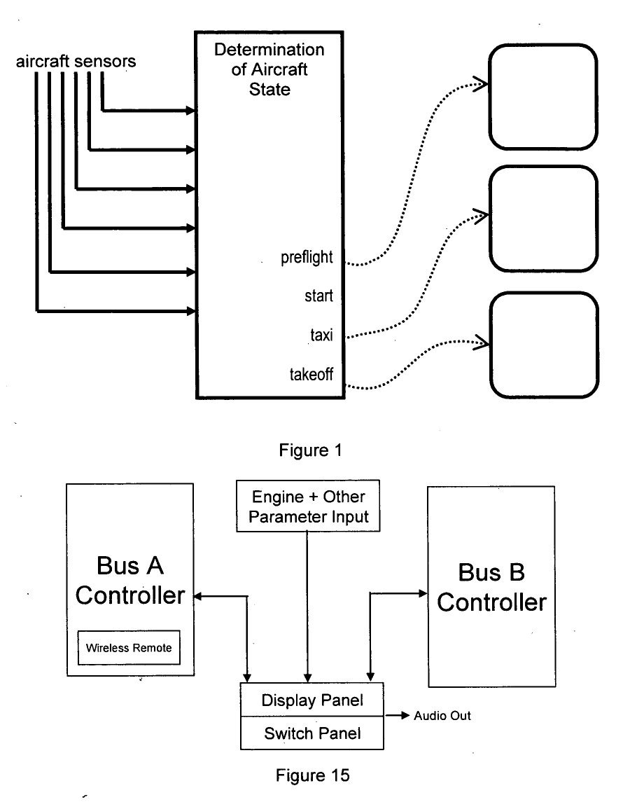

FIG. 1 is a schematic depiction of an apparatus according to the present invention. The apparatus is responsive to signals representative of various attributes of the aircraft; the attributes in the figure are for example purposes only. The apparatus comprises a state generator that determines a state of the aircraft from the signals. The apparatus further comprises a display subsystem (which can be any means or combination of means suitable for communicating information to a pilot; a visual display is a common example, audible signals comprise another common example) that can present to the pilot (or other observer) information derived from the signals, which display can be configured responsive to the state. The figure shows representative displays associated with several states—the apparatus can have a single display, which display is configured dependent on the determined state. The display can comprise one or more visual displays, audible communications, tactile or other sensory feedback, or a combination. As an example, if the aircraft sensors indicate that the aircraft is in a preflight state, then the display can be configured to display (volts and amps, for example). If the aircraft sensors are determined to indicate that the aircraft is in start state, then the display can be configured to display (oil pressure, RPM, fuel pressure, volts, amps, for example). If the aircraft sensors are determined to indicate that the aircraft is in taxi state, then the display can be configured to display manifold pressure, RPM, oil pressure, oil temperature, volts, amps, for example. If the aircraft sensors are determined to indicate that the aircraft is in takeoff state, then the display can be configured to display manifold pressure, RPM, oil pressure, oil temperature, volts, amps, for example.

Attributes. The present invention can be responsive to a variety of aircraft attributes. Those skilled in the art will appreciate many different sensors in use in contemporary aircraft. The invention can be suitable for use in connection with any characteristic related to the aircraft. The set of attributes varies depending on the capabilities and systems of each specific aircraft model. Some examples of attributes that can be useful include those described below.

Remote acknowledge button, to indicate the pilot understands and acknowledges and alert or message from the invention.

Pressure altitude. Can be sensed via static pressure.

Calibrated Airspeed. The speed of the aircraft relative to the surrounding air; generally measured with a pitot/static pressure instrument.

Groundspeed. The speed of the aircraft while on the ground, or relative to the ground, can be a backup for airspeed; can be obtained from GPS or Loran receiver using a serial or other interface.

Cabin temperature. Can be determined from a solid state analog sensor.

Engine compartment temperature. Can be determined from a solid state analog sensor.

Bus A Volts. Measured for display to the pilot, and can be used to determine if an emergency condition exists. Can be determined from an analog to digital converter.

Bus B Volts. Measured for display to the pilot, and can be used to determine if an emergency condition exists; can be determined from an analog to digital converter.

Alt A Amps. Measured for display to the pilot, and can be used to determine if an emergency condition exists; can be determined from a solid-state current sensor, Hall effect sensor, or shunt.

Alt B Amps. Measured for display to the pilot, and can be used to determine if an emergency condition exists; can be determined from a solid-state current sensor, Hall effect sensor, or shunt.

Bat A Amps. Measured for display to the pilot, and can be used to determine if an emergency condition exists; can be determined from a solid-state current sensor, Hall effect sensor, or shunt.

Bat B Amps. Measured for display to the pilot, and can be used to determine if an emergency condition exists; can be determined from a solid-state current sensor, Hall effect sensor, or shunt.

Ambient light sensor. Allows proper illumination of panel display; can be determined from a solid state photovoltaic sensor.

Pitch trim switch (up and down). A switch can allow control of electric trim speed based on aircraft state.

Roll trim switch (left and right). A switch can allow control of electric trim speed based on aircraft state.

Pitch trim position. Allows verification and display of trim position, can be state-dependent; can be determined from trim position sensors.

Roll trim position. Allows verification and display of trim position, can be state-dependent; can be determined from trim position sensors.

BAT A temp sensor. Measured to determine if an emergency condition exists; can be determined from a solid-state temperature sensor.

BAT B temp sensor. Measured to determine if an emergency condition exists; can be determined from a solid-state temperature sensor.

Flap position switch (up or down). A switch can be used to control flaps based on the aircraft state.

Flap position. Allows verification and display of flap position, can be state-dependent; can be determined from flap position sensors.

Wireless remote. A wireless remote communication facility can allow control of selected functions during certain states.

Engine Manifold Pressure. The pressure in the engine intake manifold can be useful in determining engine performance as a condition of the aircraft state; can be measured by a pressure sensor.

Engine RPM. Rotational rate of the engine (conventionally expressed in revolutions per minute) can be useful in determining engine performance as a condition of the aircraft state; can be measured using a pulse counter.

Fuel pressure. Fluid pressure in the fuel supply to the engine, conventionally measured using an analog sensor.

Fuel flow sensor. Flow rate of fuel to the engine, conventionally measured with a pulse counter. Engine Oil pressure. Fluid pressure of oil in the pressurized oil portions of the engine, conventionally measured with an analog sensor.

Engine Oil Temperature. The temperature of the oil in the engine, conventionally measured with an analog sensor.

Outside Air Temperature. The temperature of the air outside the aircraft, conventionally sensed with an analog sensor.

Exhaust Gas Temperature. The temperature of the exhaust gas from the engine (piston or turbine); can be measured with an analog sensor in the exhaust manifold several inches from the exhaust valve (or turbine combustion chamber).

Cylinder Head Temperature. The temperature of each cylinder head in the engine; can be measured with an analog sensor mounted to or in the cylinder head.

Carburetor Temperature. The temperature of air in the carburetor; can be sensed with an analog sensor.

Fuel Tank Level. An indication of the amount of fuel in each individual fuel tank, conventionally sensed with an analog sensor.

State. The invention involves determination of a state of the aircraft. Aircraft are generally considered to be in one of various states, depending on the current operating environment and requirements of the aircraft. The present invention can be described for convenience using defined states; those skilled in the art will appreciate other aircraft states compatible with the present invention, other names for similar states, and embodiments of the present invention that do not require explicit naming of an aircraft state. The state can be used to configure a display so that the display space and the pilot effort observing the display are efficient. The state can also be used to determine control settings for some aircraft subsystems, determine which contextually-relevant checklist to show, and also to determine responses to emergencies. An example set of states are described below.

Preflight. An aircraft in this state is having its systems checked prior to flight.

Start. An aircraft in this state is just starting its engine(s).

Taxi (before run-up/take-off or after landing). An aircraft in this state has checked all preflight requirements, started the engine, and is taxiing to the runway; or has landed and is taxiing from the runway.

Run-up. An aircraft in this state is substantially stationary, but is exerting its engines and testing certain systems.

Takeoff/Climb. An aircraft in this state is accelerating down the runway, or has left the surface and is gaining altitude.

Cruise. An aircraft in this state has climbed to an appropriate altitude and is flying.

Landing. An aircraft in this state is approaching the surface, slowing down, or has just encountered the surface, after flight.

Shutdown. An aircraft in this state is recognizes that the flight is over, the aircraft is stationary, and that the engine is turned off.

Maneuver. An aircraft in this state may be in any phase of flight, but will not automatically switch to another state, during times when the aircraft is performing maneuvers.

Maintenance. An aircraft in this state allows diagnostics and other maintenance tasks to be performed.

Programming. An aircraft in this state allows the system to be programmed, for example for installation of upgrades or new functionality.

Direct Pilot Input. Direct pilot input can be accommodated in various ways. As an example, discrete switches can allow the pilot to override certain functions which are programmed by the aircraft operator. As another example, the pilot can select the state of a function using a user interface (e.g., a combination of display and knobs) on the device. As another example, a pilot can provide input to the system using a wireless remote control interface.

Control. The state of the aircraft and the attributes can allow the apparatus to automatically engage, or suggest for pilot confirmation, control of certain aircraft subsystems. Direct pilot input can be incorporated to allow confirmation of control suggestion, and to allow direct pilot override or control of aircraft subsystems. Examples of subsystems that can be suitable for automated or suggested control include the following.

Flap actuator control. Control of the flap actuators, generally expressed as “flaps up” or “flaps down.” Flap actuator control can be directed by the pilot, and can be engaged or suggested if the aircraft state is preflight or shutdown and the attributes indicate no movement of the aircraft. During flight or taxi, this function is manually controlled by the pilot via a discrete switch.

Starter contactor power. Engages the starter apparatus of the aircraft engine. The starter contactor is generally a momentary on switch, that can be directly controlled by the pilot, and can be engaged or suggested if the aircraft state is preflight and the attributes indicate engine RPM=0 and groundspeed=0 and airspeed=0. The apparatus can prevent starter contactor engagement when the state is engine RPM>0.

Fuel boost pump power. Controls the fuel boost pump, where this control indicates that a power is to be supplied to the fuel boost pump. This can be directly set by the pilot, and can be engaged or suggested if the aircraft state is start, switching fuel tanks, and certain emergency states.

Pitot heater power. Controls the heater to the pitot. This can be directly engaged by the pilot, and can be engaged or suggested if the aircraft state is any state and the attributes indicate outside air temperature is below 40 deg F.

Navigation lights power. Controls the power to the navigation lights. This can be directly engaged by the pilot, and can be engaged or suggested if the aircraft state is in flight or taxi.

Taxi light power. Controls the power to the taxi lights, and typically is configurable to off, steady on, or wig/wag (i.e., lights on alternate sides flashing). This can be directly set by the pilot, and can be engaged or suggested if the aircraft state is in taxi, takeoff or landing.

Strobe lights power. Controls the power to the strobe lights, e.g., lights used to make the aircraft more visible to other aircraft. This can be directly engaged by the pilot, and can be engaged if the aircraft state is in flight.

Beacon light power. Controls the power to the beacon lights, e.g., lights used to make the aircraft more visible to other aircraft. This can be directly engaged by the pilot, and can be engaged if the aircraft state is prior to engine start through engine shutdown.

Landing light power. Controls the power to the landing lights, e.g., lights used to illuminate the runway, and typically is configurable to off, steady on, or wig/wag (i.e., lights on alternate sides flashing). This can be directly engaged by the pilot, and can be engaged if the aircraft state is takeoff, climb/cruise, or landing mode.

Panel lights. Controls the power to the panel lights, e.g., lights used to illuminate instruments on the control panel of the aircraft. This can be directly engaged by the pilot, and can be engaged if the ambient light level falls below a pre-determined level.

Map light power. Controls the power to the map lights, e.g., lights used to illuminate a map reading area of the aircraft cockpit. This can be directly engaged by the pilot.

Autopilot power. Controls the power to an autopilot, sufficient to shut it off. This can be directly engaged by the pilot, and can be engaged as appropriate to the specific autopilot.

Cross-tie contactor power. Controls the power to the cross-tie contactor, which allows current to flow from one independent electrical bus to another. This can be directly engaged by the pilot, and can be engaged if the aircraft state is in certain emergency conditions or during engine start.

IGN 1 power or override. Controls whether a first ignition circuit is either powered or shorted to ground to disable that ignition circuit to test that circuit or magneto. This can be directly engaged by the pilot, and can be engaged if the aircraft state is start, run-up, or shutdown.

IGN 2 power or override. Controls whether a second ignition circuit is either powered or shorted to ground to disable that ignition circuit to test that circuit or magneto. This can be directly engaged by the pilot, and can be engaged if the aircraft state is start, run-up, or shutdown.

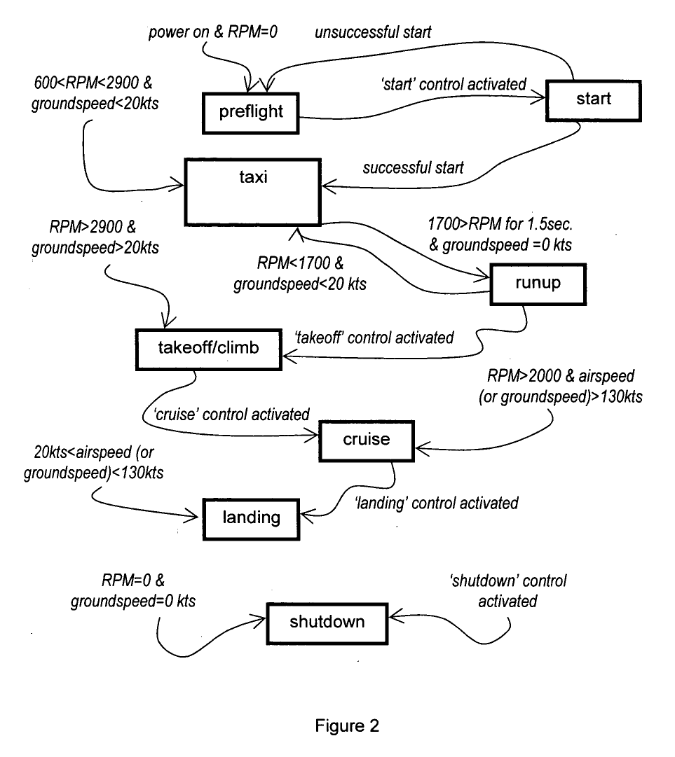

Determination of State. The state of the aircraft can be determined from its present state, from pilot input, from sensed attributes, or from a combination thereof. Various methods for determining a state are suitable for use with the present invention. As an example, the specific configuration of an aircraft can affect which attributes influence the determination of aircraft state. FIG. 2 is a schematic depiction of transitions between various states, where the states in the example comprise a subset of those described above.

The system can accommodate starting in any state. Also, there can be many more state transitions than shown in the figure; power on, reset, error detection, failure, and other conditions can contribute to state transitions. For convenience, the example will be described using only simple flight-specific attributes. The preflight state can be entered if the system determines that the aircraft power has been turned on and the engine RPM is 0. In the preflight state, the aircraft is not moving and the engine is not running.

If the pilot (or other user, for simplicity “pilot” includes any user capable of providing the indicated input or accepting the indicated output) activates a start control, then the system can transition to the start state. In the start state, the engine controls (e.g., fuel valve, fuel pump, engine ignition, etc.) are configured for starting the engine, and the engine starter is energized. Further, a contextually-relevant checklist can be displayed in this state. In the start state, the system can monitor attributes that indicate whether the engine was successfully started. If those attributes indicate that the start was not successful, the system can return to the preflight state. If those attributes indicate that the start was successful, then the system can transition to the taxi state. The taxi state can also be entered when the system determines that the engine RPM is within a defined range (e.g., 600 to 2700 RPM) and the groundspeed is less than a defined threshold (e.g., 20 kts).

In the taxi state, engine RPM and manifold pressure can be prominently displayed, and lights corresponding to taxiing can be turned on. Further, a contextually-relevant checklist can be displayed in this state. Not shown in the figure, the system can transition out of the taxi state to the preflight state if, for example, the engine RPM drops to 0. Generally, though, the aircraft will begin run-up after taxi. The system can transition to the run-up state if the attributes indicate that the engine RPM is consistently at a defined value (e.g., 1700 RPM for at least 1.5 seconds) and the aircraft groundspeed is 0. In the run-up state, if the engine slows below the defined threshold, or the groundspeed increases above 0, the system can transition back to the taxi state. While in the run-up state, a display specific to verifying the function of the propeller controls and magnetos/ignitions can be displayed, and the magnetos can be automatically individually disabled and the resultant engine performance degradation checked against allowable limits. Further, a contextually-relevant checklist can be displayed to this state.

After the run-up is complete, the taxi state can be automatically activated. From the taxi state, the pilot can manually activate the takeoff state via buttons, or the system can automatically initiate a transition into the takeoff/climb state sensed by high engine RPM and manifold pressure and increasing airspeed. Further, a contextually-relevant checklist can be displayed in this state. The system can also transition into the takeoff/climb state if it determines that the engine RPM exceeds a defined threshold (e.g., 2400 RPM) and the groundspeed exceeds a defined threshold (e.g., 20 kts). While in the takeoff/climb state, the engine RPM and manifold pressure can be prominently displayed, and certain lights are turned on, and the configuration of certain flight controls (such as trim) can be verified for the correct setting.

While in the takeoff/climb state, the pilot can manually activate the cruise state via buttons, or the system can automatically initiate a transition into the cruise state sensed by certain airspeed and engine power settings, as well as altitude level off. The system can also transition into the cruise state if it determines that the engine RPM exceeds a defined threshold (e.g., 2000 RPM) and the airspeed or groundspeed exceeds a defined threshold (e.g., 130 kts). While in the cruise state, instruments relevant to cruise flight can be displayed. Further, a contextually-relevant checklist can be displayed in this state.

The pilot can activate a landing control and initiate a transition from the cruise (or takeoff/climb) state to the landing state. Further, a contextually-relevant checklist can be displayed in this state. Also, the system can initiate a transition to the landing state if it determines that the airspeed or groundspeed is within a defined range (e.g., greater than 20 kts and less than 130 kts). While in the landing state, engine RPM and manifold pressure can be prominently displayed, and certain lights turned on, and the configuration of certain flight controls (such as trim and landing gear) can be verified for the correct setting.

The system can transition into the shutdown state when engine RPM and aircraft speed fall below thresholds. In the shutdown state, the system reverts to the preflight state.

Instrument Display Subsystem.

Conventional aircraft typically have a plurality of visual indicators, with a dedicated indicator for each attribute that might be of interest to a pilot. The present invention allows more efficient instrument display for the pilot, by allowing the information communicated to be optimized for the present state of the aircraft. The instrument panel space required, and the mental effort required by a pilot, can both be dramatically reduced. The present invention can comprise a single display, such as a flat panel display, a LCD display, an OLED display, or other programmable display. The display can comprise touch sensitive or other input technology, allowing input using the display screen. Alternatively, discrete input devices such as switches, voice input, or other input means can be used. The use of a programmable display can allow multiple information presentations, optimized based on the current state of the aircraft.

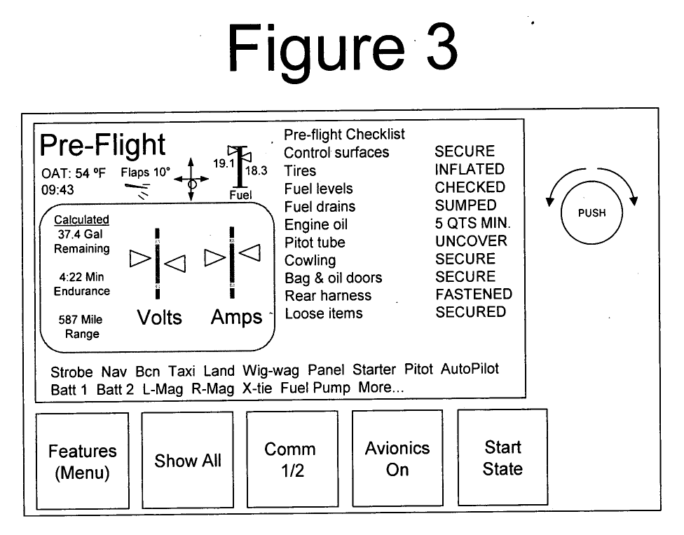

FIG. 3 is a schematic illustration of an example programmable display, configured for an aircraft in a pre-flight state. The current aircraft state (“Pre-flight”) is communicated via a display in the upper left corner, along with indicators of outside air temperature (“54° F.” in the example), current time (“09:43” in the example), flaps (“10° ” in the example), trim position (using crosshairs and a circle in the example), and fuel level in each of two tanks (“19.1” and “18.3” in the example). The lower left portion of the display prominently displays several attributes especially important to a pilot of an aircraft in this state: remaining fuel (“37.4 Gal” in the example), flight time with the remaining fuel (“4:22” in the example), flight distance with the remaining fuel (“527 Miles” in the example), and volts and amps for each of two electrical systems. The configuration of attribute displays reduces the visual clutter presented to a pilot, allowing the pilot to easily comprehend the attributes most important to the present aircraft state. The right portion of the display presents a checklist appropriate to a pre-flight state to a pilot. The progress through the checklist can be automated, for example by sensing of the corresponding attributes. The progress can also be manually controlled by a pilot, for example by manipulating an input device (on the upper right in the example) to select and check elements in the list. Progress through the checklist can be communicated to a pilot by sounds or by changing an aspect of the display of the items (e.g., changing color, format, highlighting, underline, outline, font, etc.). A lower portion of the display can present the state (on or off, automatic or manual mode) of items controlled by the invention. The state can be communicated by, as examples, changing color, format, highlighting, underline, outline, font, etc. of the display corresponding to the state of the item. A plurality of inputs (shown as buttons in the example) can be presented along the bottom of the display, allowing a pilot to access certain functions or command certain actions such as control the display (“Menu” and “Show All” in the example), select items to control manually (“Comm 1/2” in the example), turn on avionics (“Avionics On”), and initiate a transition to a “Start” aircraft state.

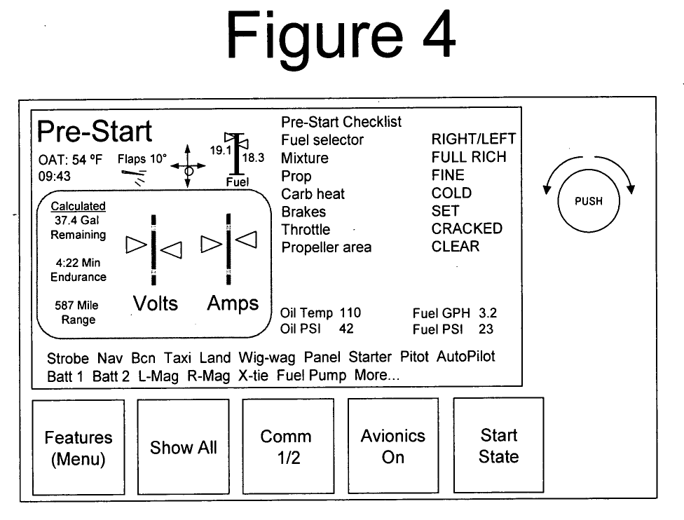

FIG. 4 is a schematic illustration of an example programmable display, configured for an aircraft in a pre-start state. The current aircraft state (“Pre-start”) is communicated via a display in the upper left corner, along with indicators of outside air temperature (“54° F.” in the example), current time (“09:43” in the example), flaps (“10°” in the example), trim position (using crosshairs and a circle in the example), and fuel level in each of two tanks (“19.1” and “18.3” in the example). The lower left portion of the display prominently displays several attributes especially important to a pilot of an aircraft in this state: remaining fuel (“37.4 Gal” in the example), flight time with the remaining fuel (“4:22” in the example), flight distance with the remaining fuel (“527 Miles” in the example), and volts and amps for each of two electrical systems. The configuration of attribute displays reduces the visual clutter presented to a pilot, allowing the pilot to easily comprehend the attributes most important to the present aircraft state. The right portion of the display presents a checklist appropriate to a pre-start state to a pilot. The progress through the checklist can be automated, for example by sensing of the corresponding attributes. The progress can also be manually controlled by a pilot, for example by manipulating an input device (on the upper right in the example) to select and check elements in the list. A lower portion of the display can present the state (on or off, automatic or manual mode) of items controlled by the invention. A plurality of inputs (shown as buttons in the example) can be presented along the bottom of the display, allowing a pilot to control a fuel pump “Fuel Pump” in the example), control the display (“Menu” and “Show All” in the example), select communications channels (“Comm 1/2” in the example), and initiate a transition to a “Start” aircraft state.

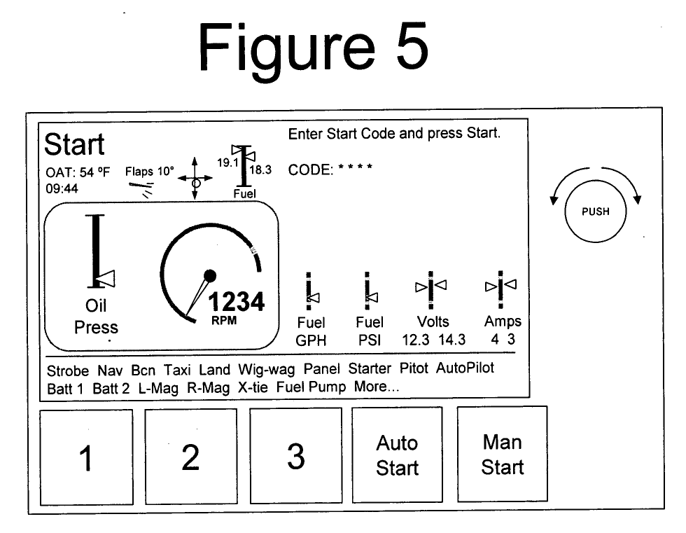

FIG. 5 is a schematic illustration of an example programmable display, configured for an aircraft in a start state (but prior to engine start). The current aircraft state (“Start”) is communicated via a display in the upper left corner, along with indicators of outside air temperature (“54° F.” in the example), current time (“09:44” in the example), flaps (“10°” in the example), trim position (using crosshairs and a circle in the example), and fuel level in each of two tanks (“19.1” and “18.3” in the example). The display communicates several other attributes especially important in this state in a more prominent manner: Fuel GPH, Fuel PSI, Volts on each of two batteries, and Amps from each of two generators. Two attributes, Oil Press(ure) and engine RPM, are displayed most prominently in the lower left portion. The configuration of attribute displays reduces the visual clutter presented to a pilot, allowing the pilot to easily comprehend the attributes most important to the present aircraft state. The upper right portion provides for input of a starter code (to discourage unauthorized operation). A plurality of status indicators are presented along the lower edge of the display. A plurality of buttons are provided along the bottom of the display: buttons for numeric input (of the start code, for example), along with buttons for auto start or manual start of the engine. An input dial and switch is available at the right of the display, allowing a pilot to select any of the various inputs and select or activate them.

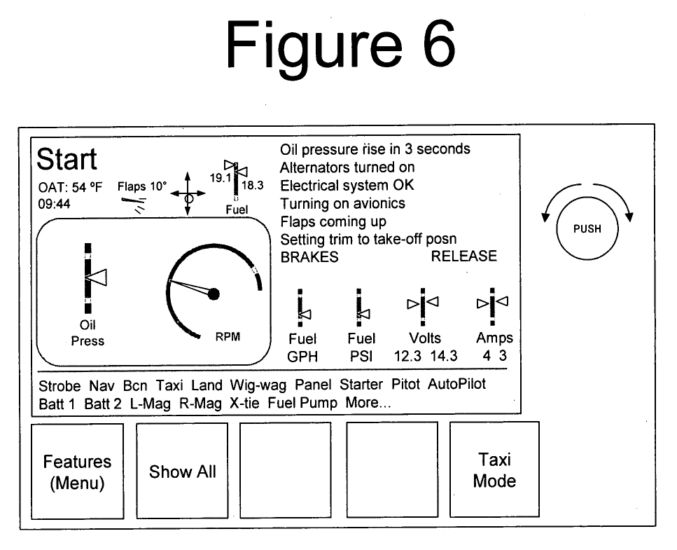

FIG. 6 is a schematic illustration of an example programmable display, configured for an aircraft in a start state (just after engine start). The current aircraft state (“Start”) is communicated via a display in the upper left corner, along with indicators of outside air temperature (“54° F.” in the example), current time (“09:44” in the example), flaps (“10°” in the example), trim position (using crosshairs and a circle in the example), and fuel level in each of two tanks (“19.1” and “18.3” in the example). The display communicates several other attributes especially important in this state in a prominent manner on the right side of the display: Fuel GPH, Fuel PSI, Volts on each of two batteries, and Amps from each of two generators. Two attributes, Oil Press(ure) and engine RPM, are displayed most prominently in the lower left portion. The configuration of attribute displays reduces the visual clutter presented to a pilot, allowing the pilot to easily comprehend the attributes most important to the present aircraft state. The upper right portion provides a log of actions associated with engine start, allowing a pilot to monitor the condition of the aircraft. A plurality of status indicators are presented along the lower edge of the display. A plurality of inputs (shown as buttons in the example) can be presented along the bottom of the display, allowing a pilot to control the display (“Menu” and “Show All” in the example), and initiate a transition to a “Taxi” aircraft state. An input dial and switch is available at the right of the display, allowing a pilot to select any of the various inputs and select or activate them.

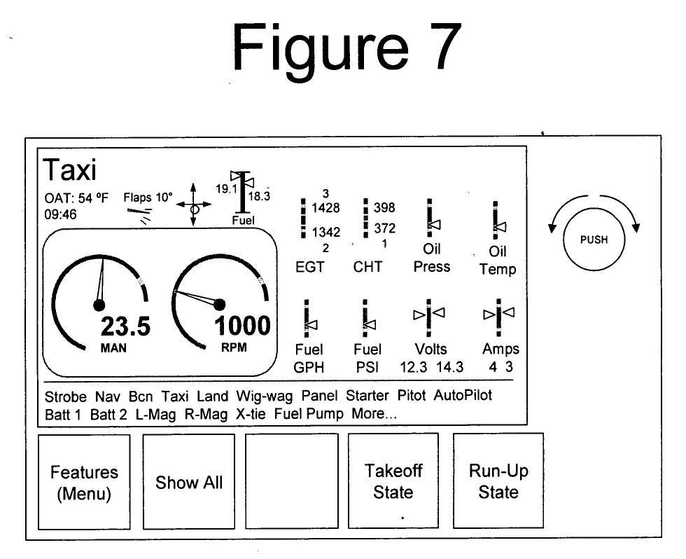

FIG. 7 is a schematic illustration of an example programmable display, configured for an aircraft in a taxi state. The current aircraft state (“Taxi”) is communicated via a display in the upper left corner, along with indicators of outside air temperature (“54° F.” in the example), current time (“09:46” in the example), flaps (“10°” in the example), trim position (using crosshairs and a circle in the example), and fuel level in each of two tanks (“19.1” and “18.3” in the example). The display communicates several other attributes especially important in this state in a prominent manner on the right side of the display: EGT, CHT, Oil Press(ure), Oil Temp(erature), Fuel GPH, Fuel PSI, Volts on each of two batteries, and Amps from each of two generators. Two attributes, MAN(ifold pressure) and engine RPM, are displayed most prominently in the lower left portion. The configuration of attribute displays reduces the visual clutter presented to a pilot, allowing the pilot to easily comprehend the attributes most important to the present aircraft state. A plurality of status indicators are presented along the lower edge of the display. A plurality of inputs (shown as buttons in the example) can be presented along the bottom of the display, allowing a pilot to control the display (“Menu” and “Show All” in the example), and indicate a transition to either “Takeoff” or “Run-up” aircraft states. An input dial and switch is available at the right of the display, allowing a pilot to select any of the various inputs and select or activate them.

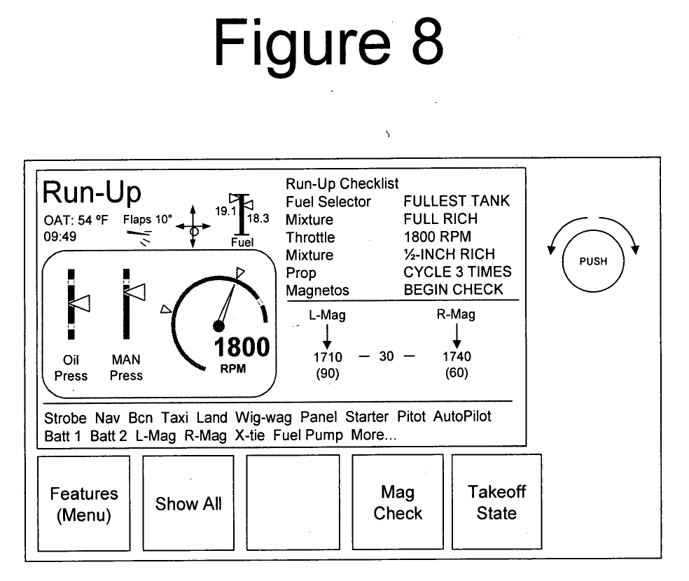

FIG. 8 is a schematic illustration of an example programmable display, configured for an aircraft in a run-up state. The current aircraft state (“Run-up”) is communicated via a display in the upper left corner, along with indicators of outside air temperature (“54° F.” in the example), current time (“09:49” in the example), flaps (“10°” in the example), trim position (using crosshairs and a circle in the example), and fuel level in each of two tanks (“19.1” and “18.3” in the example). Three attributes, Oil Press(ure), MAN(ifold pressure), and engine RPM, are displayed most prominently in the lower left portion. The configuration of attribute displays reduces the visual clutter presented to a pilot, allowing the pilot to easily comprehend the attributes most important to the present aircraft state. The upper right portion provides a log of actions and controllable attributes associated with run-up, allowing a pilot to control and monitor the condition of the aircraft. A plurality of status indicators are presented along the lower edge of the display. A plurality of inputs (shown as buttons in the example) can be presented along the bottom of the display, allowing a pilot to control the display (“Menu” and “Show All” in the example), initiate a check of the magneto (“Mag check” in the example), and initiate a transition to a “Takeoff” aircraft state. The system can provide for an automated magneto check: (a) individually short each magneto, (b) record and optionally display engine RPM initially and with the shorted magneto, (c) compare the results between the two magnetos, (d) verify that the results are within limits. The results of the automated magneto check can be communicated to the pilot via the display. An input dial and switch is available at the right of the display, allowing a pilot to select any of the various inputs and select or activate them.

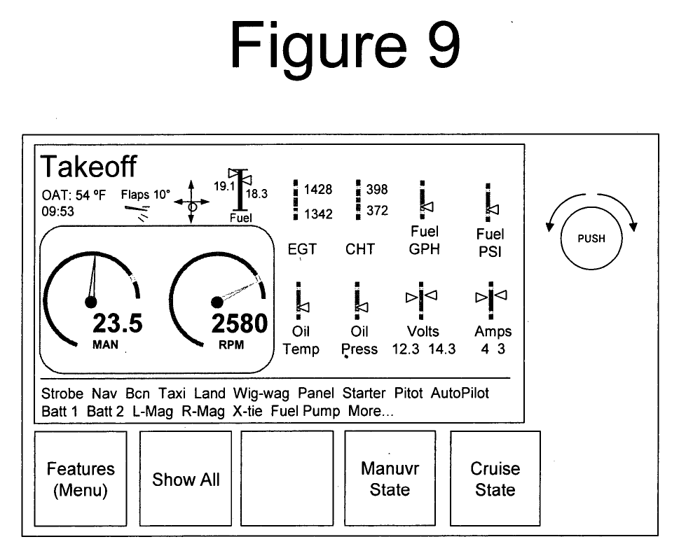

FIG. 9 is a schematic illustration of an example programmable display, configured for an aircraft in a Takeoff state. The current aircraft state (“Takeoff”) is communicated via a display in the upper left corner, along with indicators of outside air temperature (“54° F.” in the example), current time (“09:53” in the example), flaps (“10°” in the example), trim position (using crosshairs and a circle in the example), and fuel level in each of two tanks (“19.1” and “18.3” in the example). The lower left portion of the display prominently displays two attributes especially important to a pilot of an aircraft in this state: MAN(ifold pressure) and engine RPM. Several other attributes useful in this state are displayed, less prominently, in the lower right portion of the display. The configuration of attribute displays reduces the visual clutter presented to a pilot, allowing the pilot to easily comprehend the attributes most important to the present aircraft state. The upper right portion of the display can present a checklist appropriate to a takeoff state to a pilot; or (as shown in the figure) can present aircraft attributes important to an aircraft in this state: EGT, CHT, Fuel GPH, Fuel PSI, Oil Temp(temperature), Oil Press(pressure), Volts on each of two batteries, and Amps from each of two generators. Two attributes, MAN(manifold pressure) and engine RPM are displayed most prominently in the lower left portion. The configuration of attribute displays reduces the visual clutter presented to a pilot, allowing the pilot to easily comprehend the attributes most important to the present aircraft state. A plurality of status indicators are presented along the lower edge of the display. A plurality of inputs (shown as buttons in the example) can be presented along the bottom of the display, allowing a pilot to control the display (“Menu” and “Show All” in the example), and initiate a transition to either “Maneuver” or “Cruise” aircraft states. An input dial and switch is available at the right of the display, allowing a pilot to select any of the various inputs and select or activate them.

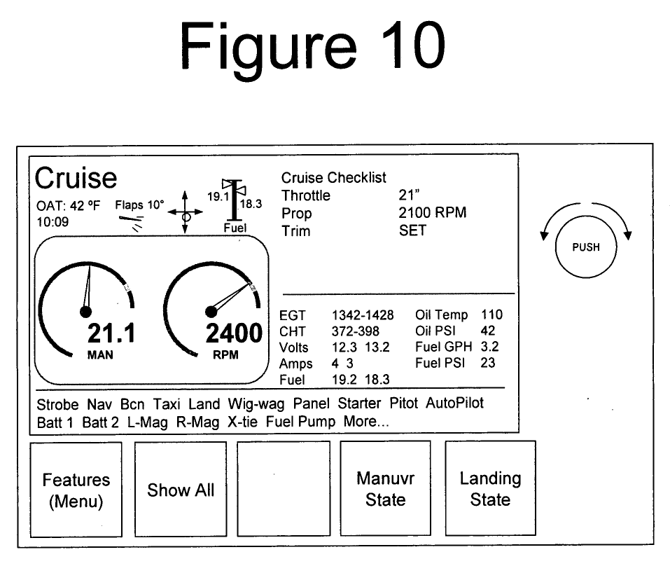

FIG. 10 is a schematic illustration of an example programmable display, configured for an aircraft in a Cruise state. The current aircraft state (“Cruise”) is communicated via a display in the upper left corner, along with indicators of outside air temperature (“54° F.” in the example), current time (“10:09” in the example), flaps (“10°” in the example), trim position (using crosshairs and a circle in the example), and fuel level in each of two tanks (“19.1” and “18.3” in the example). The lower left portion of the display prominently displays two attributes especially important to a pilot of an aircraft in this state: MAN(manifold pressure) and engine RPM. Several other attributes useful in this state are displayed, less prominently, in the lower right portion of the display. The configuration of attribute displays reduces the visual clutter presented to a pilot, allowing the pilot to easily comprehend the attributes most important to the present aircraft state. The upper right portion of the display presents a checklist appropriate to a cruise state to a pilot. The checklist can be displayed on entering the cruise state, without requiring pilot intervention to select or otherwise access the specific checklist. The progress through the checklist can be automated, for example by sensing of the corresponding attributes. The progress can also be manually controlled by a pilot, for example by manipulating an input device (on the upper right in the example) to select and check elements in the list. A lower portion of the display can present status. A plurality of inputs (shown as buttons in the example) can be presented along the bottom of the display, allowing a pilot to control the display (“Menu” and “Show All” in the example), and initiate a transition to a “Landing” aircraft state.

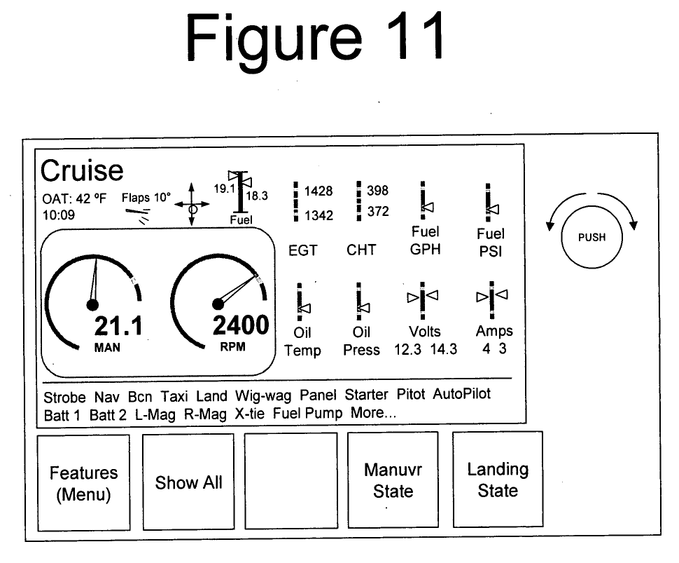

FIG. 11 is a schematic illustration of an example programmable display, configured for an aircraft in a cruise state (after completion of a checklist such as that in the example of FIG. 10). The current aircraft state (“Cruise”) is communicated via a display in the upper left corner, along with indicators of outside air temperature (“54° F.” in the example), current time (“09:43” in the example), flaps (“10°” in the example), trim position (using crosshairs and a circle in the example), and fuel level in each of two tanks (“19.1” and “18.3” in the example). The display communicates several other attributes especially important in this state in a prominent manner on the right side of the display: EGT, CHT, Fuel GPH, Fuel PSI, Oil Temp(erature), Oil Press(ure), Volts on each of two batteries, and Amps from each of two generators. Two attributes, MAN(ifold pressure) and engine RPM are displayed most prominently in the lower left portion. The configuration of attribute displays reduces the visual clutter presented to a pilot, allowing the pilot to easily comprehend the attributes most important to the present aircraft state. A plurality of status indicators are presented along the lower edge of the display. A plurality of inputs (shown as buttons in the example) can be presented along the bottom of the display, allowing a pilot to control the display (“Menu” and “Show All” in the example), and initiate a transition to either “Maneuver” or “Landing” aircraft states. An input dial and switch is available at the right of the display, allowing a pilot to select any of the various attributes and select or activate them.

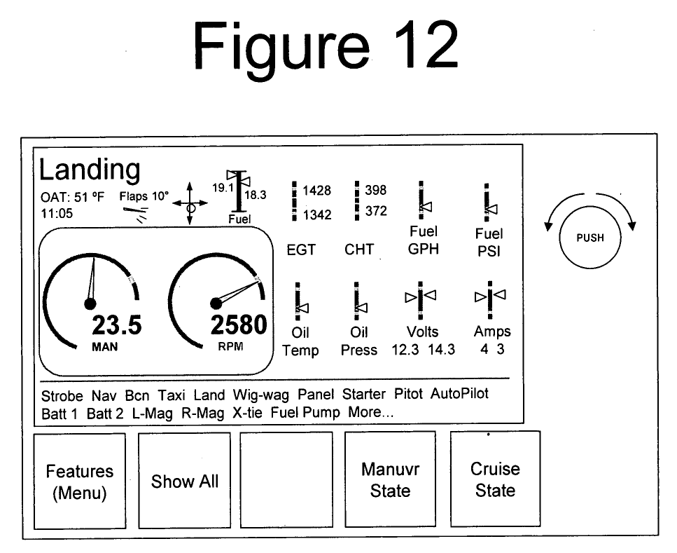

FIG. 12 is a schematic illustration of an example programmable display, configured for an aircraft in a landing state. The current aircraft state (“Landing”) is communicated via a display in the upper left corner, along with indicators of outside air temperature (“54° F.” in the example), current time (“11:05” in the example), flaps (“10°” in the example), trim position (using crosshairs and a circle in the example), and fuel level in each of two tanks (“19.1” and “18.3” in the example). The display communicates several other attributes especially important in this state in a prominent manner on the right side of the display: EGT, CHT, Fuel GPH, Fuel PSI, Oil Temp(temperature), Oil Press(pressure), Volts on each of two batteries, and Amps from each of two generators. Two attributes, MAN(manifold pressure) and engine RPM are displayed most prominently in the lower left portion. The configuration of attribute displays reduces the visual clutter presented to a pilot, allowing the pilot to easily comprehend the attributes most important to the present aircraft state. A plurality of status indicators are presented along the lower edge of the display. A plurality of inputs (shown as buttons in the example) can be presented along the bottom of the display, allowing a pilot to control the display (“Menu” and “Show All” in the example), and initiate a transition to either “Maneuver” or “Cruise” aircraft states. An input dial and switch is available at the right of the display, allowing a pilot to select any of the various inputs and select or activate them.

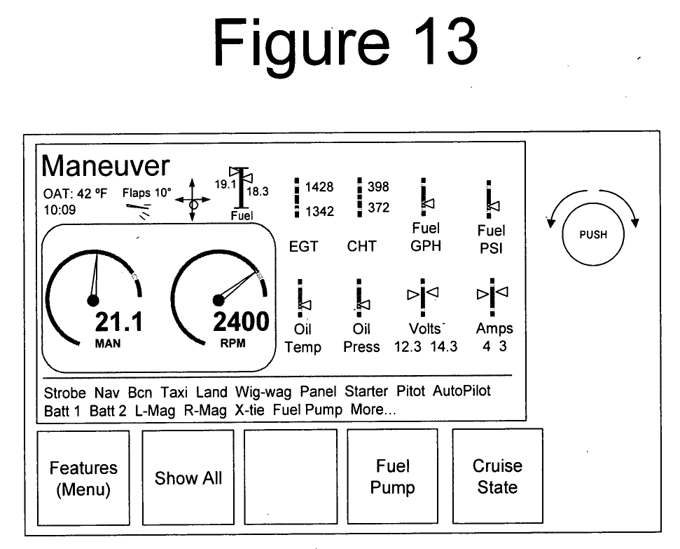

FIG. 13 is a schematic illustration of an example programmable display, configured for an aircraft in a Maneuver state. The current aircraft state (“Maneuver”) is communicated via a display in the upper left corner, along with indicators of outside air temperature (“54° F.” in the example), current time (“10:09” in the example), flaps (“10°” in the example), V, and fuel level in each of two tanks (“19.1” and “18.3” in the example). The display communicates several other attributes especially important in this state in a prominent manner on the right side of the display: EGT, CHT, Fuel GPH, Fuel PSI, Oil Temp(temperature), Oil Press(pressure), Volts on each of two batteries, and Amps from each of two generators. Two attributes, MAN(manifold pressure) and engine RPM are displayed most prominently in the lower left portion. The configuration of attribute displays reduces the visual clutter presented to a pilot, allowing the pilot to easily comprehend the attributes most important to the present aircraft state. A plurality of status indicators are presented along the lower edge of the display. A plurality of inputs (shown as buttons in the example) can be presented along the bottom of the display, allowing a pilot to control the display (“Menu” and “Show All” in the example), to control a fuel pump (“Fuel Pump” in the example), and initiate a transition to a “Cruise” aircraft state. An input dial and switch is available at the right of the display, allowing a pilot to select any of the various inputs and select or activate them.

The previous descriptions generally assumed a piston engine aircraft. Those skilled in the art will appreciate adjustments to the sensors, display, and state to accommodate turbine-powered aircraft. For example, engine RPM and manifold pressure can be replaced with turbine N1% or turbine N2%.

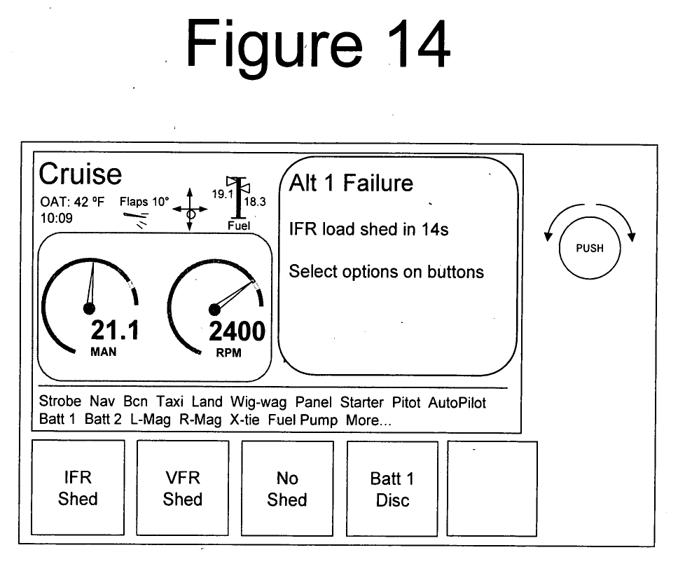

FIG. 14 is a schematic illustration of an example programmable display, configured for an aircraft in a Cruise state, in the presence of a failure detected by the system. The display is similar to that described earlier, except that a Failure indication has been placed prominently on the display (e.g., by size, color, font, blinking, audible signals, etc.). The pilot's attention can be easily drawn to the failure indication by the prominent display. Some failures may be amenable to automatic correction or compensation. Some may require pilot input.

The Features menu brings up tertiary functions such as cabin temp control and fine-tuning the panel light dimming, as examples.

### EXAMPLE EMBODIMENT

FIG. 15 is a schematic block diagram of an example embodiment of the present invention. A Display Panel accommodates communication of information to a pilot. A Switch Panel accommodates communication of information from a pilot. A single or dual redundant controller(s) can be used to determine state, to set controls, to control the display, to accept input in between the sensors and the display/switch. Sensors corresponding to various attributes of aircraft, such as those discussed above, provide information to the controller. The controller determines the state of the aircraft from the attributes, for example as described above. The controller sends information to the display which accepts input based on the determined state. For example, the controller can accept input from one or more switches, where the switches are defined to have specific meanings depending on the determined state. The controller initiates control of various aircraft attributes, for example those described above, based on the determined state and on pilot input. While the controller and display functions are described separately for convenience, they can be integrated in a single system, or part of the controller can be integrated with the display while part is separate from the display.

A suitable display panel can comprise appropriate technology for aircraft use. A width of no more than 6.25″ can allow the system to readily fit in a standard radio rack. The system can operate in all temperature ranges expected in the aircraft cockpit environment, for example, typically −30 deg C. to +65 deg C. The screen can be daylight readable, for example with a transflective screen or transmissive screen with a brightness greater than about 500 nits. A suitable switch panel can comprise a portion of a touch sensitive display configured by the controller for pilot input. It can also comprise discrete switches mounted near the display, voice recognition, or remotely mounted switches. Switches can have high quality, gold-plated contacts for desirable reliability. The sensor interface converts analog signals from commercially-available temperature, pressure, and other analog sensors to digital signals that can be processed by the microcomputer. The controllers can be implemented using commercially available switching devices and current sensing devices, with interfaces to the microcomputer.

A suitable controller can be implemented with a conventional single board microcomputer, with discrete logic, with programmable logic, or application specific integrated circuits, or combinations thereof. A typical microprocessor is a Motorola HCS12 or comparable with built-in serial I/O and at least 256 KB of non-volatile memory. A programmable controller implementation can execute software developed using conventional programming techniques such as C programming language.

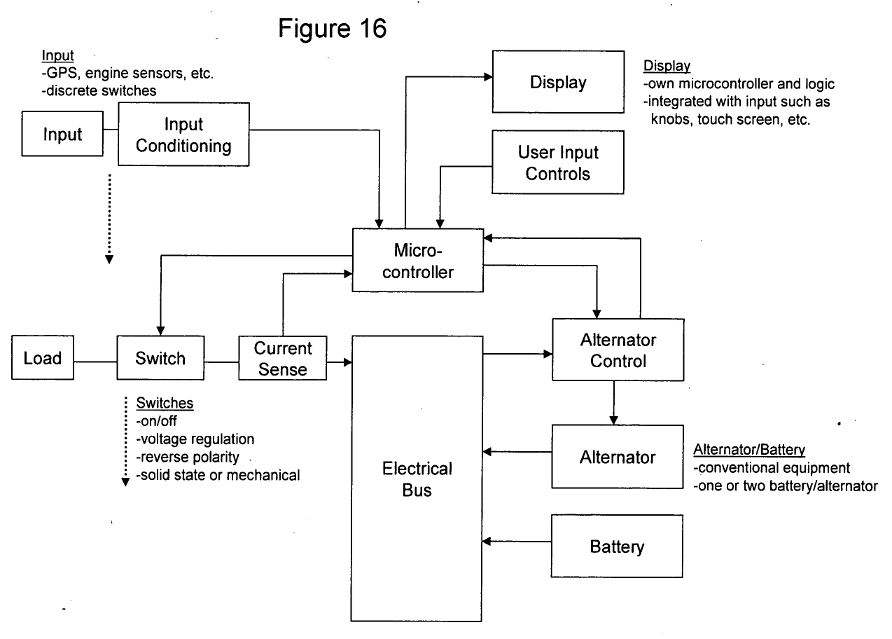

FIG. 16 is a schematic illustration of an embodiment of the present invention. A Microcontroller is programmed to implement functionality such as that described in the examples described herein. The Microcontroller accepts Input from sensors and other systems, configured for access by the Microcontroller, if needed, by appropriate Input Conditioning. The Microcontroller also accepts input from the user via User Input Controls. The Microcontroller outputs signals to control a Display, mounted to communicate with the pilot. An Alternator Control system communicates with the Microcontroller and controls and senses operation of one or more alternators. The Alternators and Battery connect to an Electrical Bus. The Microcontroller controls various Switches (and senses their configuration by, for example, Current Sense). The Switches can control various Loads, such as various systems of the aircraft.

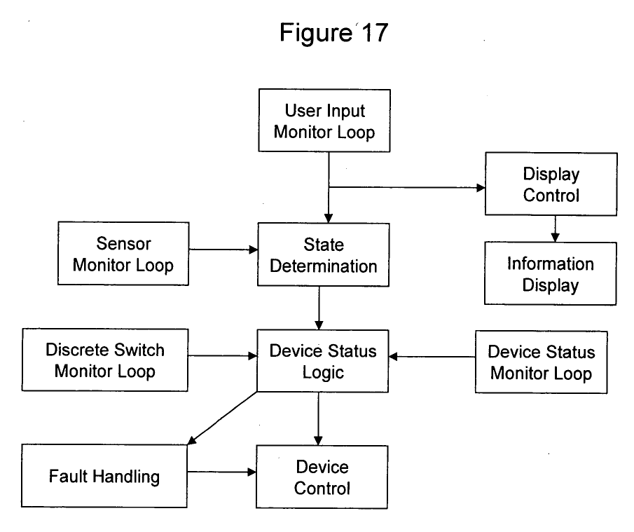

FIG. 17 is a schematic illustration of computer software suitable for implementing an embodiment of the present invention. A User Input Monitor Loop monitors input from the user; a Sensor Monitor Loop monitors input from aircraft sensors. A State Determination function determines the state of the aircraft from the user input and the aircraft sensors. A Device Status Monitor Loop and a Discrete Switch Monitor Loop provide input to Device Status Logic, which can control devices (Device Control) in combination with a Fault Handling function. A Display Control function can combine information from the various other functions to control an Information Display. Those skilled in the art will appreciate various other implementations, including other software approaches, approaches using multiple processors, and other combinations of hardware and software.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

1) An apparatus for reporting a condition of an aircraft to a user, comprising:
a) A state generator, determining a state of the aircraft responsive to signals representative of a plurality of aircraft attributes;
b) A display subsystem displaying information concerning the condition of the aircraft responsive to the state generator and one or more of the signals.

2) An apparatus as in claim 1, wherein the signals include one or more signals chosen from the group consisting of: engine RPM, engine oil pressure, engine fuel pressure, engine manifold pressure, air speed, altitude, GPS-provided signals, ground speed, distance to destination, time to destination, engine compartment temperature, bus voltage, alternator current, turbine N1%, turbine N2%, and turbine exhaust gas temperature.

3) An apparatus as in claim 1, wherein the state generator determines a state of the aircraft responsive to signals representative of a plurality of aircraft attributes and responsive to pilot direction.

4) An apparatus as in claim 3, wherein the pilot direction includes one or more directions chosen from the group consisting of: mode selection, display override, mode confirmation, action confirmation, and next mode direction.

5) An apparatus as in claim 1, wherein the display subsystem includes visible display of one or more of: aircraft mode indicator, an aircraft attribute selected according to the aircraft mode, an aircraft attribute whose display characteristics are dependent on the aircraft mode, textual indication of aircraft mode, textual indication of an aircraft attribute, textual display of information related to aircraft mode.

6) An apparatus as in claim 1, further comprising a control subsystem controlling one or more controllable aircraft attributes responsive to the state of the aircraft.

7) An apparatus as in claim 6, wherein the control subsystem is also responsive to one or more of the signals.

8) An apparatus as in claim 6, wherein the controllable aircraft attribute is chosen from the group consisting of: aircraft lighting, flaps, landing gear, trim, cabin temperature, fuel tank selection, compartment latches, engine ignition, alternator settings, battery contactor, bus crosstie contactor, avionics, pump, motor, and engine starter.

9) A method of reporting a condition of an aircraft to a user, comprising:
a) Sensing a plurality of aircraft attributes;
b) Determining an aircraft state from the plurality of attributes;
c) Reporting to the user a condition of the aircraft responsive to the determined state and one or more of the aircraft attributes.

10) A method of communicating information related to an aircraft, comprising:
a) Accepting information representative of a plurality of attributes of the aircraft;
b) Determining from at least some of the attributes a selected state, selected as one of a plurality of defined states that best corresponds to the present condition of the aircraft;
c) Selecting a subset of the attributes, where the subset is dependent on the selected state;
d) Communicating the attributes in the selected subset.

11) A method as in claim 10, wherein communicating the attributes in the selected subset comprises communicating the attributes in the selected subset in a more prominent manner than other attributes.

12) A method as in claim 11, wherein communicating in a more prominent manner comprises displaying the attributes in the selected subset in a manner selected from the group consisting of: different display brightness, different backlight brightness, different display format, different display size, different display font, different completeness of information relating to the attribute, different color, and combinations thereof.

13) A method as in claim 10, further comprising:
a) Determining if an attribute is not within a set of values predetermined for that attribute when the aircraft is in the determined state, and, if so, then
b) Communicating that condition.

14) A method as in claim 13, wherein communicating the condition comprises displaying the out-of-bounds attribute.

15) A method as in claim 13, wherein communicating the condition comprises displaying a warning indication.

16) A method as in claim 13, wherein communicating the condition comprises an audible signal, a visible alarm indication, a tactile alarm, or combinations thereof.

17) A method as in claim 13, further comprising:
a) Accepting an indication that the out-of-bounds attribute should be changed, and, after accepting the indication;
b) Activating one or more aircraft controls in a manner predetermined for the out-of-bounds attribute and determined state.

18) A method as in claim 13, further comprising:
a) Accepting an indication that the aircraft should be operated in cognizance of the out-of-bounds attribute, and, after accepting the indication;
b) Activating one or more aircraft controls in a manner predetermined for the out-of-bounds attribute and the determined state.

19) An apparatus as in claim 1, further comprising a magneto check system, adapted to
a) determine engine RPM;
b) short one magneto in the aircraft;
c) determine engine RPM with the magneto shorted;
d) repeat steps a), b), and c) with at least one other magneto in the aircraft; and
e) determine if the engine RPMs determined in step a) and c) are within acceptable limits.

20) A method as in claim 13, further comprising:
a) Accepting a conditions indication of whether the aircraft is operating in instrument meteorological conditions or visual meteorological conditions;
b) Activating one or more aircraft controls in a manner predetermined for the out-of-bounds attribute, the determined state, and the conditions indication.

21) An apparatus as in claim 1, wherein the display subsystem comprises definitions of a plurality of checklists, where at least a first checklist is associated with a first aircraft state; and wherein the display subsystem displays the first checklist when the aircraft is in the first state.

22) A method as in claim 9, further comprising communicating to the user a checklist associated with the determined state.
